(19) United States
(12) Patent Application Publication
(10) Pub. No.: US 2012/0110885 A1
(43) Pub. Date: May 10, 2012

(54) METHOD FOR PRODUCING A GUN BARREL, DEVICE FOR PRODUCING A GUN BARREL AND A GUN BARREL

(75) Inventor: Torolf Pelin, Jorvas (FI)

(73) Assignee: CARREL INNOVATIONS OY, Jorvas (FI)

(21) Appl. No.: 13/384,416

(22) PCT Filed: Jul. 15, 2010
(86) PCT No.: PCT/FI10/00046

§ 371 Date: Jan. 17, 2012

(30) Foreign Application Priority Data
Jul. 17, 2009 (FI) 20090277
Oct. 6, 2009 (FI) 20090369
Mar. 23, 2010 (FI) 20100126

(51) Int. Cl. F41A 21/02; B21D 53/00; B21B 19/00; F41A 21/00; F41A 21/18; B82Y 30/00

(52) U.S. Cl. 42/75.02; 42/76.1; 42/78; 42/76.02; 72/77; 72/68; 977/742

(57) ABSTRACT

A method for producing a gun barrel, in which the barrel is formed from a pipe blank (1) in which barrel rifles (2) are formed against a mandrel (3) having grooves (2b) shaped as the rifles.

This invention relates to a method for producing a gun barrel by forming the barrel from a pipe blank.

Gun barrels are currently made of metal. A hole is drilled in a metal blank, such as an elongated shaft, and the hole is provided with rifles by trimming, “Broach Rifling”, hammering “Hammer Forget Rifling”, or a button drawing technique called “Button Rifling”. A fourth previously known method uses electrochemical engraving, called “Electrochemical Rifling”.

The purpose of this invention is to achieve a perfectly straight and durable gun barrel produced by a completely new method. This production method is considerably faster than all the methods for producing gun barrels known per se. The method in accordance with the invention is characterised by the fact that barrel rifles are formed in a pipe blank using moulding techniques against a mandrel having grooves shaped as the rifles.

The invention also relates to a device for producing a gun barrel. The device in accordance with the invention is characterised by the fact that the device consists of press means, whose press force together with a movement generated outside the pipe blank achieves a deformation of the pipe blank by moulding techniques, so that barrel rifles having the shape of the grooves in the mandrel are produced in the inner wall of the pipe blank.

The invention also relates to a gun barrel, which is characterised by the fact that the pipe blank is provided with a support pipe, which gives the barrel strength and resistance.

Various embodiments of the invention are set forth in the dependent claims of the set of claims.

The invention is described below by means of an example and with reference to the accompanying drawings, in which

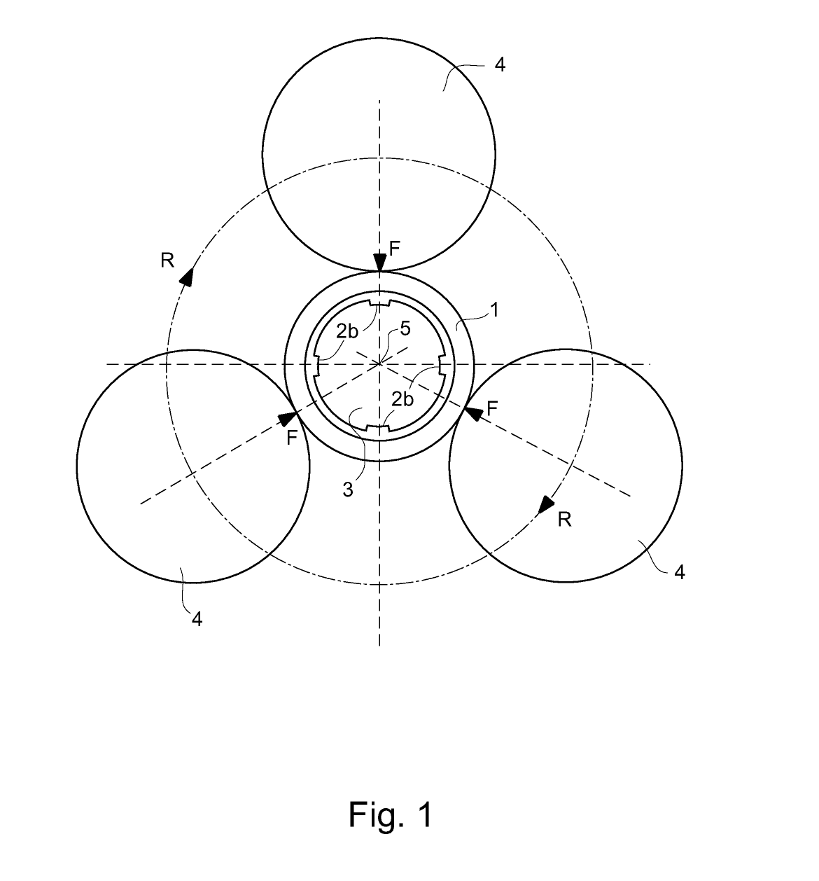

FIG. 1 shows moulding of a pipe blank for a gun barrel using press rolls, viewed in the longitudinal direction of the pipe blank,

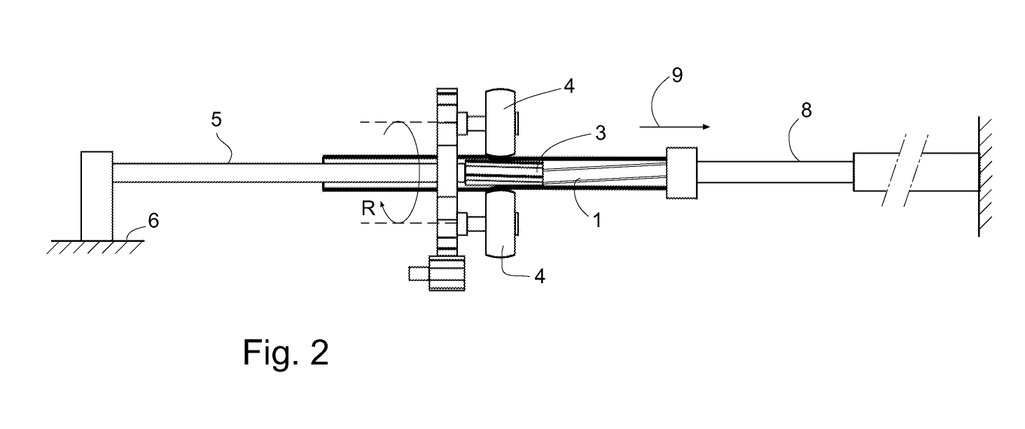

FIG. 2 is a lateral view of the essential parts of the machine required for the production of the gun barrel using press rolls,

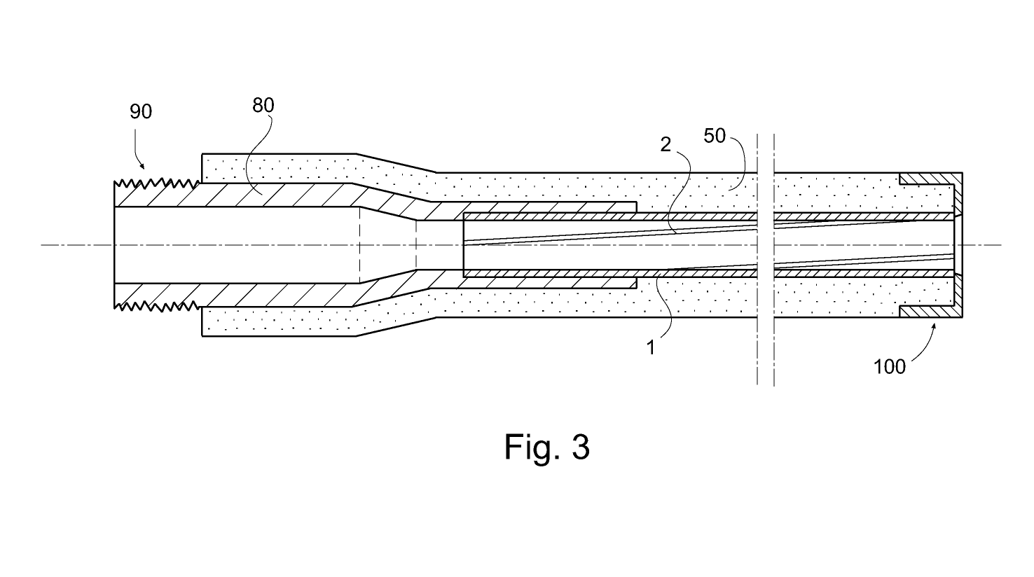

FIG. 3 is a longitudinal sectional view of one embodiment of the gun barrel,

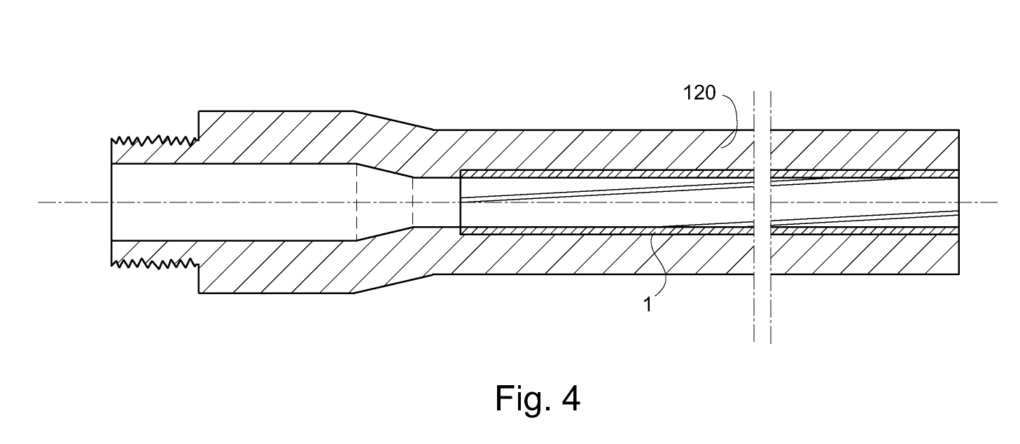

FIG. 4 is a sectional view of a second embodiment of the gun barrel,

FIG. 5 illustrates a metal tube mounted on a mandrel,

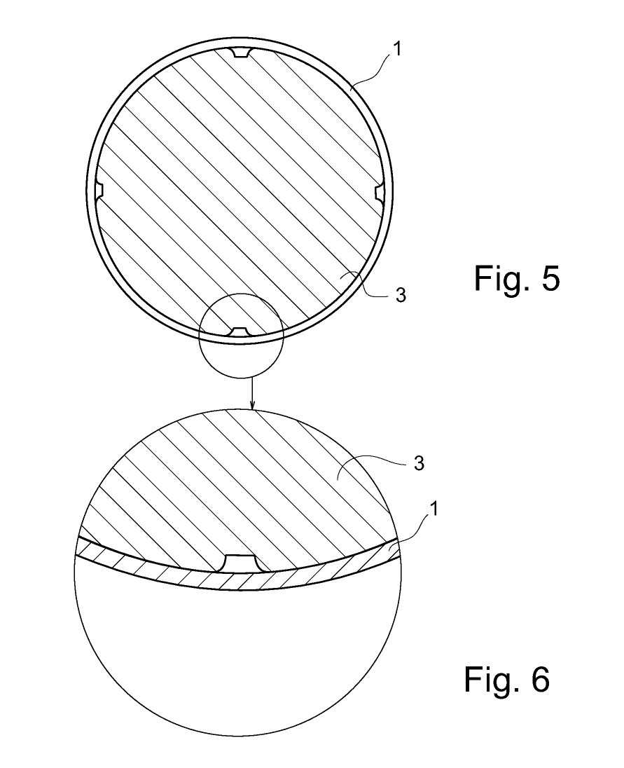

FIG. 6 is an enlargement of the ring of FIG. 5,

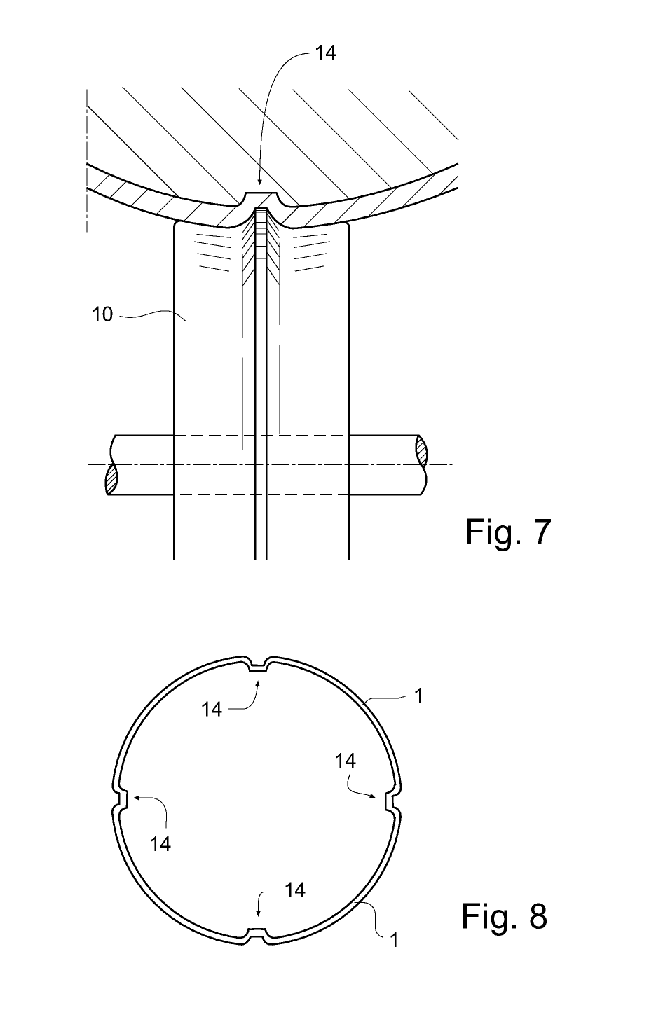

FIG. 7 shows the moulding of a rifle, with a press roll moving in parallel with the rifle,

FIG. 8 shows a barrel pipe with four rifles moulded by the method illustrated in FIG. 7,

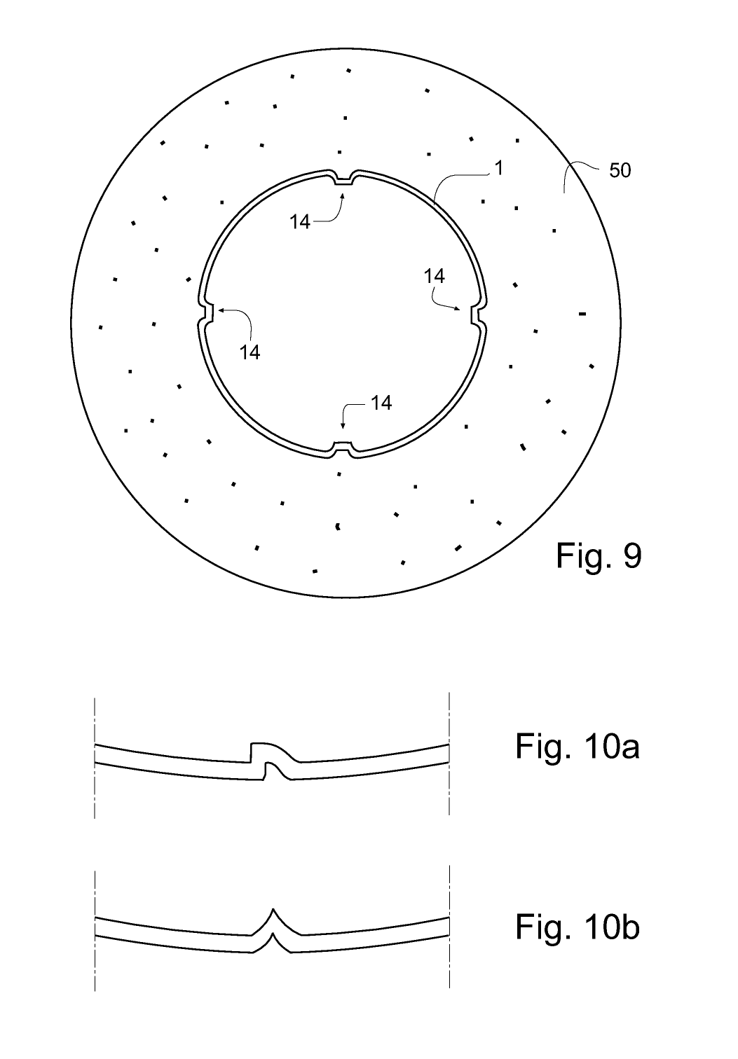

FIG. 9 shows a barrel pipe, on top of which a support pipe made of e.g. carbon fibre or glass fibre has been produced,

FIGS. 10a and 10b show rifles with different shapes,

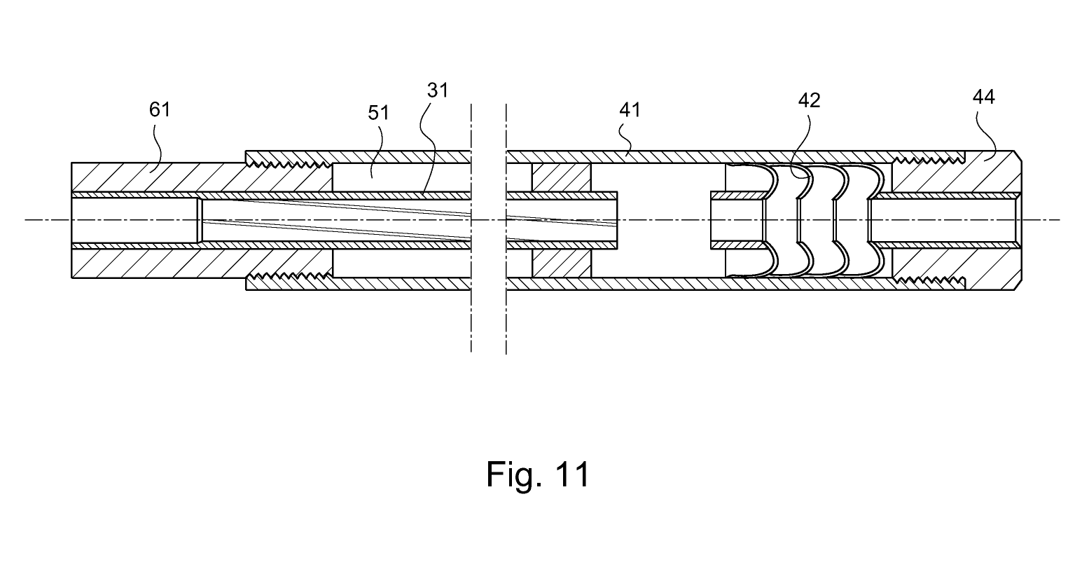

FIG. 11 shows a barrel with a sound damper integrated in its external support pipe,

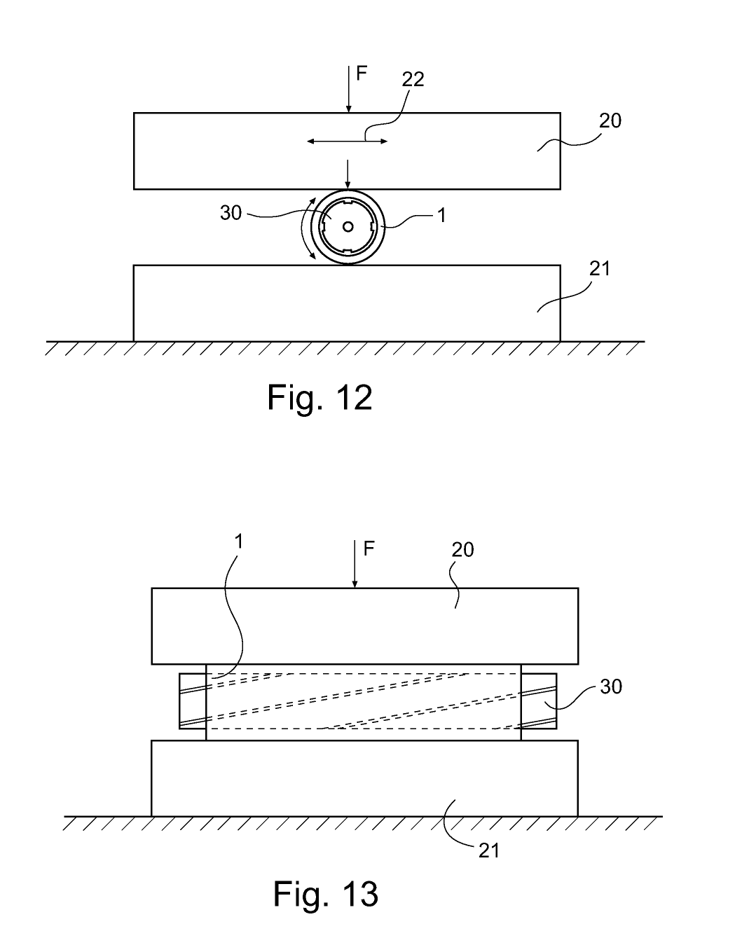

FIG. 12 shows the moulding of a pipe blank between two planes,

FIG. 13 illustrates the same as FIG. 12, viewed from another direction and

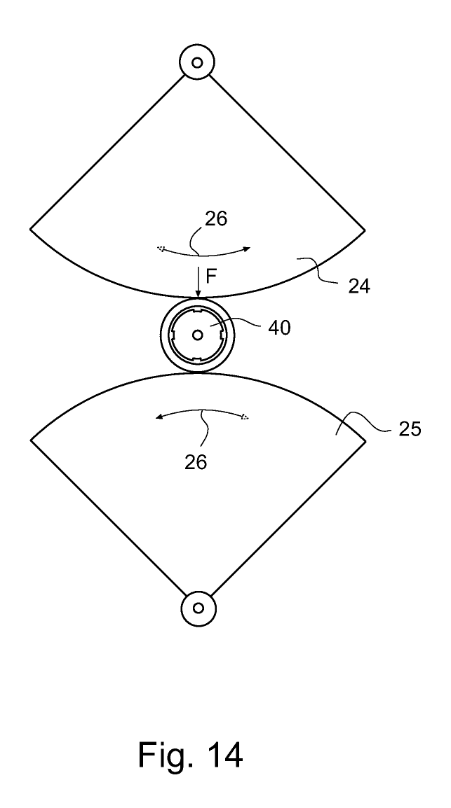

FIG. 14 illustrates the moulding of a pipe blank between two curved planes reciprocating into opposite directions.

### THE METHOD

Barrel rifles are moulded in a seamless pipe blank of stainless or acid-proof steel for a gun barrel using moulding techniques against a mandrel 3, which is provided with grooves 2b shaped as the rifles 2. The moulding in FIGS. 1 and 2 is performed with the aid of press rolls 4. The press rolls 4 are substantially perpendicular to the longitudinal axis 5 of the pipe blank 1. The press rolls 4 are rotated around the pipe blank 1, so that the wall of the pipe blank is pressed against the mandrel 3 and barrel rifles 2 are produced in the inner wall of the pipe blank. The pipe blank 1 is pulled over the mandrel 3 and the press rolls R are simultaneously rotated around the pipe blank while being pressed F against the mandrel 3. The press force F is generated by means of technical solutions known per se, such as eccentric pieces.

The moulding of a barrel blank 1 in FIG. 7 is performed by means of press rolls 10. The press rolls follow the same direction as the rifles 14. FIG. 8 shows a finished barrel pipe and FIG. 9 shows a barrel pipe equipped with a support pipe 50, which may be made of carbon fibre, glass fibre or any other fibre reinforcement known per se, or an additional supporting metal tube.

The moulding of the barrel blank 1 in FIGS. 12 and 13 is performed between two planes 20, 21. The upper plane reciprocates in the direction of the arrow 22. The plane 22 presses the pipe blank 1 rotating between the planes and the mandrel 30 with a force F. The grooves provided in the mandrel 30 are reproduced as rifles in the pipe blank 1. FIG. 13 shows that the mandrel 30 is longer than the pipe blank. There are two reasons for this: a) the pipe blank 1 extends in the course of the moulding, b) the mandrel 30 will not require shifting in the longitudinal direction during the moulding. After the moulding step has been completed, the mandrel 30 is removed and the barrel is ready to be mounted in a gun, such as a pistol, or the cartridge chamber of a pistol.

The moulding in FIG. 14 is on principle performed in the same manner as in FIGS. 12 and 13, but the two planes 24, 25 are both curved and move alternately into opposite directions, as indicated by arrows 26, with the pipe blank 1 and the mandrel 30 placed between the planes rotating in a stationary position, and if necessary, mounted onto bearings at both ends.

The Device

The embodiment of a device for producing a gun barrel shown in FIGS. 1 and 2 consists of press rolls 4, which generate a press force F, which in a rotatory movement R around the pipe blank and using moulding techniques produces a deformation in the pipe blank, so that barrel rifles 2 in a shape corresponding to the grooves 2b in the mandrel are produced in the inner wall. The mandrel 3 is stationary and attached to a base 7 by means of an elongated shaft 6, and the pipe blank 1 can be pulled by a drawing device 8 over the mandrel 3 in the direction indicated by the arrow 9. The press rolls 4 rotate around the pipe blank while the drawing device 8 pulls the pipe blank 1 in the direction indicated by the arrow 9. Tests producing bores 308 and 22LR have proved that the method and the device achieve first-class, perfectly straight gun barrels, rapidly and at low cost. The tests used acid-proof AISI316 steel.

Gun Barrel

The gun barrel in FIG. 3 is equipped with a support pipe 50, which gives the barrel strength and resistance. The support pipe 50 may consist of carbon fibre, glass fibre or carbon nanotube-reinforced epoxy (Hybtonit®). The gun barrel is fixed to the cartridge chamber 80. The cartridge chamber has threads 90 for attachment of the gun barrel to the bolt housing. A metal ring 100 is provided in the front part of the barrel for protection of the fibre structures of the support pipe 50. The support pipe may also be made of hard and tensile steel, such as spring steel 120 (FIG. 4). These solutions (FIGS. 3 and 4) provide a barrel having such resistance that it is explosion-proof, even if some foreign object, such as snow, sand or earth would enter it, or say, a bullet would be left in the barrel.

The barrel shown in FIG. 11 is mainly intended for caliber 22LR. The gun barrel was produced using the method and the device described above (FIGS. 1 and 2). Tests conducted with a barrel of this type proved its operation to be perfect. Bullets made one single hole in the target, with the bullet holes on top of each other. The distance from the target was 30 metres.

The gun barrel consists of a rifled barrel pipe 31 and an outer mantle 41 provided on the outside of the barrel pipe. The outer mantle 41 is a cylindrical pipe, and an interstice 51 is provided between the barrel pipe 31 and the outer mantle. A sound damper unit 42 is provided in front of the barrel pipe 31 and inside the outer mantle 41. The gun barrel can be attached to the bolt housing of the gun by means of compression fit or threads, using a bushing 61 provided at the butt, and the sound damper unit 42 can be attached with the aid of the helicoidal bushing 44 to which it is attached.

1. A method for producing a gun barrel, in which the barrel is formed from a pipe blank (1), wherein the barrel rifles (2, 14) are formed in the pipe blank (1) using moulding techniques against a mandrel (3) having grooves (2b) shaped as the rifles.

2. A method as defined in claim 1, wherein the pipe blank (1) is a drawn, seamless pipe made of stainless or acid-proof steel.

3. A method as defined in claim 1, wherein the moulding is performed by means of press rolls (4).

4. A method as defined in claim 1, wherein the press rolls are substantially perpendicular to the longitudinal axis (5) of the pipe blank (1).

5. A method as defined in claim 1, wherein the press rolls (4) are rotated around the pipe blank (1) so that the wall of the pipe blank is pressed against the mandrel (3) and barrel rifles (2) are produced in the inner wall of the pipe blank.

6. A method as defined in claim 1, wherein the pipe blank (1) is pulled over the mandrel (3) and the press rolls are simultaneously rotated around the pipe blank while being pressed (F) against the mandrel.

7. A method as defined in claim 1, wherein the moulding is performed by rolling between two plates (20, 21) so that the entire pipe blank (1) and the mandrel (3) placed within are entirely located between the plates.

8. A method as defined in claim 1, wherein the surfaces of the plates (24, 25) are curved and they move into opposite directions (26) while being rolled, so that the barrel blank (1) placed inbetween and the mandrel (3) placed within rotate in a stationary position relative to the movements of the plates.

9. A device for producing a gun barrel, wherein the device comprises press means (4), whose press force (F) together with a movement (R) generated outside the pipe blank (1) produces a deformation of the pipe blank by moulding techniques, so that barrel rifles (2) shaped as the grooves (2b) in the mandrel (3) are produced in the inner walls of the pipe blank.

10. A device for producing a gun barrel as defined in claim 9, wherein the mandrel (3) is stationary and attached by an elongated shaft (6) to a base (7) and in that the pipe blank (1) can be pulled by a drawing device (8) over the mandrel (3) in the direction indicated by the arrow (9).

11. A device as defined in claim 9, wherein the length of the mandrel is (3) substantially equal to or longer than that of the pipe blank (1) and in that the roll plates (20, 21, 24, 25) have substantially the same width as the pipe blank and the mandrel within the pipe blank.

12. A gun barrel, which has been produced by the method defined in claim 1, wherein the pipe blank (1) is equipped with a support pipe (10), which gives the barrel strength and resistance.

13. A gun barrel as defined in claim 12, wherein the support pipe (50, 120, 41) is made of carbon fibre, glass fibre or carbon nanotube-reinforced epoxy (Hybtonit®) (FIG. 3).

14. A gun barrel as defined in claim 12, wherein the support pipe (120) is made of hard and tensile steel, such as spring steel (FIG. 4).

15. A gun barrel as defined in claim 12, in which the support pipe consists of an outer mantle (41) outside the barrel pipe, wherein the outer mantle (41) is a substantially cylindrical pipe and that an interstice (51) is provided between the barrel pipe (31) and the outer mantle, and in that a sound damper unit (42) is provided in front of the barrel pipe and inside the outer mantle.

16. A gun barrel as defined in claim 15, in which the support pipe consists of an outer mantle provided outside the barrel pipe, wherein the gun barrel can be attached to the bolt housing of the gun by means of a bushing (61) provided at the butt using compression fit or threads and in that the sound damper unit (42) can be attached by means of the helicoidal bushing (44) to which the sound damper unit (42) is attached.
